(19) United States
(12) Patent Application Publication
(10) Pub. No.: US 2019/0375221 A1
(43) Pub. Date: Dec. 12, 2019

(54) SECURITY DEVICE COMPONENTS AND METHODS OF MANUFACTURE THEREOF

(71) Applicant: DE LA RUE INTERNATIONAL LIMITED, Basingstoke, Hampshire (GB)

(72) Inventor: Brian HOLMES, Fleet (GB)

(73) Assignee: DE LA RUE INTERNATIONAL LIMITED, Basingstoke, Hampshire (GB)

(21) Appl. No.: 16/462,966

(22) PCT Filed: Nov. 22, 2017
(86) PCT No.: PCT/GB2017/053510

§ 371 Date: May 22, 2019

(30) Foreign Application Priority Data
Nov. 22, 2016 (GB) 1619731.1

(51) Int. Cl. B41M 3/14; B42D 25/324; B42D 25/328; B42D 25/425

(52) U.S. Cl. CPC B41M 3/14; B42D 25/425; B42D 25/328; B42D 25/324

(57) ABSTRACT

A security device component having a layer of cured curable material carrying a surface relief structure in the surface thereof. A first sub-region of the surface relief structure has a first relief structure. A second sub-region of the surface relief structure, abutting the first sub-region, has a second relief structure different from the first relief structure. The first relief structure defines a primary portion of the surface relief structure and the second relief structure defines an ancillary portion of the surface relief structure. The ancillary portion of the surface relief structure has a thickness that decreases from the primary portion of the surface relief structure towards at least one lateral edge of the layer of curable material.

### FIELD OF THE INVENTION

The present invention relates to security device components suitable for use in the production of security devices for banknotes, identity documents, passports, certificates and the like, as well as methods of manufacturing such security device components. In particular, the present invention relates to security devices produced by a cast-cure process, in which a surface relief structure is cast into a material and the material cured to fix the surface relief structure in the material.

### DESCRIPTION OF THE RELATED ART

Articles of value, and particularly documents of value such as banknotes, cheques, passports, identification documents, certificates and licences, are frequently the target of counterfeiters and persons wishing to make fraudulent copies thereof and/or changes to any data contained therein. Typically such objects are provided with a number of security devices for checking the authenticity of the object. By “security device” we mean a feature which it is not possible to reproduce accurately by taking a visible light copy, e.g. through the use of standardly available photocopying or scanning equipment. Examples include lenticular devices, moire magnification devices, diffractive devices, refractive devices and tactile devices.

Many of these security devices make use of a surface relief structure carried in one or more layers of the security device. For example, security devices that operate using lenses, such as lenticular devices or moiré magnification devices, typically include a transparent layer whose surface is shaped so as to produce the desired light-focussing property across the layer, while a hologram, as an example of a diffractive device, may be provided by forming a diffractive surface relief across a layer of suitable material.

One way of providing these surface relief structures in a layer is by using a cast-cure process to form and then fix the surface relief structure in a curable material, which is typically malleable until cured. An example of a known system for forming a security device component is shown in FIG. 1A. These cast-cure processes typically provide a curable material in a deformable state to a support layer in a region corresponding to the desired final footprint of the security device component. A cast having, in a corresponding casting region, the inverse of the desired surface relief structure inset into the surface of the cast is then brought into contact with the curable material. The cast is typically is pressed against the curable material at high pressure to ensure the curable material fully conforms to the cast, before the curable material is cured while in contact with the cast, thereby fixing the surface relief structure in the cured curable material. The cast and the patch of curable material are shown in more detail in FIG. 2A.

As the curable material is initially deformed by the cast, excess curable material is pushed towards the periphery of the casting region. It has been found that, owing to the high pressure with which the cast is pressed into the curable material, a large pressure spike is produced at the lateral edges of the casting region, i.e. at the periphery of the inset casting relief structure. It has been observed that this pressure spike deforms the support layer, and even the surface pressing the support layer and curable material against the cast, and excess curable material escapes the casting region and fills the volume of the deformation. The excess curable material that is pushed out of the casting region, causing the deformation of the support layer or pressing surface, is then cured together with the rest of the curable material. Once the cast is removed, at least some of the deformation in the support layer will be reversed by the elasticity of said support layer, resulting in a ridge of cured curable material existing about the periphery of the surface relief structure in the cured curable material. The final security device component, including this ridge, is shown in FIG. 2B.

The ridge that is formed at the periphery of the cured curable material has been found to be up to two to three times the height of the maximum height of the surface relief structure formed by the cast. Such ridges are generally undesirable as they can often be detected tactilely and can impede further processing of the security device component in the formation of a complete security device.

A number of means of preventing formation of this ridge have been attempted.

Providing the curable material in a thinner layer or over a smaller region than the casting region reduces the amount of excess curable material, but can result in certain elements of the surface relief structure being incomplete, leading to an inferior appearance of any final security device, or the edges of the surface relief structure being imprecisely defined.

It is therefore desirable that a method of producing security device components is provided that eliminates or reduces the above described phenomenon of the ridge of curable material about the periphery of the security device component without suffering the drawbacks of the known solutions.

### SUMMARY OF THE INVENTION

In accordance with a first aspect of the present invention, there is provided a method of forming a security device component comprising: providing a support layer and a casting relief structure; applying a curable material to a surface across a surface region thereof using an application device, the application device being adapted to transfer the curable material onto the surface in a first sub-region of the surface region with a first average volume per unit area and to transfer the material onto the surface in a second sub-region of the surface region with a second average volume per unit area, wherein the curable material in the second sub-region abuts the curable material in the first sub-region, wherein the curable material in the second sub-region provides at least one lateral edge of the curable material across the surface region, and wherein the second average volume per unit area is less than the first average volume per unit area; wherein the surface is either a surface of the support layer or a casting surface of the casting relief structure; bringing the casting relief structure and the support layer together across the surface region such that the curable material lies therebetween; curing the curable material, thereby fixing a surface relief structure in the surface of the cured curable material; and separating the casting relief structure and the support layer such that the cured curable material is carried by the support layer; whereby the cured curable material applied in the first sub-region of the surface region carries a primary portion of the surface relief structure, the primary portion of the surface relief structure corresponding to at least a part of the casting relief structure in the casting surface, and the cured curable material applied in the second sub-region of the surface region carries an ancillary portion of the surface relief structure, the ancillary portion of the surface relief structure having a thickness that decreases from the primary portion of the relief structure towards a lateral edge of the cured curable material.

In this method, the curable material is applied with a volume per unit area that is reduced towards at least some of the periphery of the layer of curable material. Preferably, this is achieved by providing an application device that is adapted to transfer the curable material onto the surface in the second sub-region with a volume per unit area that decreases, preferably continuously, across the second sub-region from the first sub-region towards the lateral edge of the curable material. Providing curable material with lower volume per unit area in the second region has been found to reduce the prominence of any ridge of curable material at the at least one lateral edge of the cured curable material, as will be described in more detail below.

It will be appreciated that, while the present method only refers to one curable material, multiple curable materials could be used. For example, the application device may be adapted to transfer two or more different curable materials simultaneously onto the surface. In such cases, a first curable material may make up a first portion or portions of the first and/or second surface sub-regions and a second curable material make up the remaining portion or portions of the first and/or second surface sub-regions. These curable materials may, for example, be of a different colour and might provide the curable material across the surface region with a macroscopic pattern.

It will also be noted that the present method is suitable for either application of the curable material onto the support layer, before bringing the casting relief structure into contact with the curable material on the support layer, or application of the curable material onto the casting surface, before bringing the support layer into contact with the curable material on the casting surface. Descriptions of features of embodiments below which relate to either one of these alternatives will be understood to apply equally to both alternatives.

The method includes the step of bringing the casting relief structure and the support layer together across the surface region such that the curable material lays therebetween. In this step, the casting surface carrying the casting relief structure and the surface of the support layer may be pressed together to cause deformation of the curable material in accordance with the casting relief structure and to allow the curing to fix the surface relief structure in the surface of the curable material.

In some embodiments, the application device is adapted to transfer the curable material onto the surface in the first sub-region with a volume per unit area that is generally constant across the first sub-region. This may ensure that the primary portion of the surface relief structure is consistently and completely formed. In other embodiments, the application device is adapted to transfer the curable material onto the surface in the first and second sub-regions with a volume per unit area that varies continuously across the first and second sub-regions.

In all of the above mentioned alternatives, what is consistent is that the curable material in the second sub-region is transferred onto the surface with a lower average volume per unit area than the curable material transferred onto the surface in the first sub-region. Reducing the amount of curable material near the at least one lateral edge means that there is less excess curable material that might be pushed out of the casting region. However, while less curable material is provided overall as compared with an equivalent area of curable material not having the reduced volume per unit area in the second sub-region, this reduction in curable material may be achieved while still providing curable material in high enough quantity in the first sub-region to completely form the primary portion of the relief structure, preventing the reduction in overall volume of material from causing the formation of incomplete surface relief elements in the primary portion of the relief structure.

In some embodiments, the application device comprises an application surface having an array of recesses located across an application surface region, the application surface region corresponding to the surface region, the array of recesses being configured to receive at least some of the curable material, wherein a first sub-set of the array of recesses are located across a first application surface sub-region corresponding to the first sub-region of the surface and are configured to transfer the curable material onto the surface in the first sub-region of the surface, and wherein a second sub-set of the array of recesses are located across a second application surface sub-region corresponding to the second sub-region of the surface and are configured to transfer the curable material onto the surface in the second sub-region of the surface, the average volume of the first sub-set of the array of recesses being greater than the average volume of the second sub-set of the array of recesses. A gravure printing system is an example of an application device that functions by receiving material in an array of recesses and then transferring that material from the recesses onto a surface. In these embodiments, the recesses, known as gravure cells in gravure processes, may be varied in their shape, size, depth and/or density in order to provide the different volumes of curable material per unit area to the first and second sub-regions.

Where it is desired that the curable material is applied with a constant volume per unit area in the first region, each recess of the first sub-set of the array of recesses may have substantially the same volume. Additionally, the array of recesses may be uniformly distributed across the first application surface sub-region. In contrast, to provide the curable material with a volume per unit area that decreases across the second region, the recesses of the second sub-set of the array of recesses may vary in their volume and/or may be non-uniformly distributed across the second application surface sub-region. To provide that the volume per unit area decreases towards the lateral edge (or periphery of the device component) the recesses of the second sub-set of the array of recesses may decrease in volume across the second application surface sub-region from the first sub-set towards the lateral edge of the array of recesses. Alternatively, or in addition, the spacing of the recesses may increase from the first sub-set towards the lateral edge of the array of recesses.

Typically, the methods comprising an application device having an application surface with an array of recesses will comprise the step of applying the curable material to the application surface such that it is received in the array of recesses across the application surface region. In some cases, the curable material will coat the entire application surface region, including non-recessed portions. In these cases, the volume per unit area of curable material not in the recesses may be the same in both regions such that the difference in volume per unit area of curable material in the recesses provides an overall difference in volume per unit area of curable material in the first and second application surface sub-regions. However, in alternative embodiments, the method may comprise removing curable material from the application surface that is not received in the array of recesses across the application surface region before applying the curable material to the surface. In these cases, the volume per unit area of curable material may be defined solely by the volume and spacing of the recesses and therefore more precisely controlled.

In other embodiments, the application device comprises an application surface configured to receive the curable material, wherein the application surface comprises a surface relief across an application surface region, the application surface region corresponding to the surface region, wherein the surface relief has a first average height in a first application surface sub-region corresponding to the first sub-region of the surface and the surface relief has a second average height in a second application surface sub-region corresponding to the second sub-region of the surface, wherein the first average height is greater than the second average height. Flexographic material application systems are examples of application systems that utilise a surface relief to vary the material transferred to a surface in a region-wise manner. Application devices such as flexographic devices have a surface that is pressed onto a source of curable material to receive the curable material. These application devices typically receive the curable material with a thickness that correlates to the contact pressure between the application surface and the source of curable material. Therefore, providing a surface relief on the application surface can alter the contact pressure in a region-wise manner and consequently provide differing volume per unit areas of received and ultimately transferred curable material.

In these embodiments, preferably the second application surface sub-region has a height that gradually decreases across the second application surface sub-region. Preferably, the height decreases from the first application surface sub-region to a lateral edge (or periphery) of the application surface region.

In some embodiments, the application device comprises an application surface configured to receive the curable material, wherein the application surface comprises a plurality of raised surface regions across an application surface region, the raised surface regions being configured to receive the curable material and the application surface region corresponding to the surface region, wherein a first sub-set of the plurality of raised surface regions are provided in a first application surface sub-region corresponding to the first sub-region of the surface and a second sub-set of the plurality of raised surface regions are provided in a second application surface sub-region corresponding to the second sub-region of the surface, and wherein the first sub-set of the plurality of raised surface regions make up a first proportion of the total area of the first application surface sub-region and the second sub-set of the plurality of raised surface regions make up a second proportion of the total area of the second application surface sub-region, the first proportion being greater than the second proportion.

As mentioned above, typically, these embodiments will comprise coating the application surface in the curable material before applying the curable material to the surface, wherein the step of coating the application surface in the curable material comprises bringing the application surface in contact with a curable material source surface, the curable material source surface having the curable material substantially uniformly distributed thereon, such that the application surface receives the curable material from the curable material source surface having the first volume per unit area in the first application surface sub-region and the second volume per unit area in the second application surface sub-region. Where the first and second application surface sub-regions differ in their height, the varying contact pressure provides the difference in volume per unit area of the received curable material. In contrast, where the first and second application surface sub-regions comprise raised regions (which may not vary in their height) varying in their coverage of the respective sub-regions, it is the variance in coverage of raised regions that provides the difference in the volume per unit area of the curable material.

In particularly preferable embodiments, the primary portion of the surface relief structure is an optically active surface relief structure. By optically active, we mean that the structure controls light by one or more of reflection, refraction and diffraction to produce an optical effect, preferably an optically variable effect (i.e. one causing the appearance to vary with viewing angle). Examples of optically active structures include refractive imaging or focussing elements or element arrays (e.g. lenses), microfocussing elements or element arrays, reflective imaging elements (e.g. mirrors), diffractive surface reliefs including first order diffractive relief structures and zero order diffractive structures (e.g. diffraction gratings), refractive prismatic structures, reflective triangulated structures (e.g.

micromirrors) and diffractive Fresnel lenses. While it is preferable that the primary portion of the surface relief structure is optically active, in alternative embodiments the primary portion of the surface relief structure may be optically inactive, e.g. a tactile relief structure. Preferably the ancillary portion of the surface relief structure is an optically inactive surface relief structure. However, alternatively the ancillary portion could also be optically active. For example, the ancillary portion of the surface relief structure may define a series of lenses that decrease in height from the primary portion of the surface relief structure towards the lateral edge of the curable material.

The primary portion of the surface relief structure may be configured to provide all or part of a desired security device feature. For example, the primary portion of the surface relief structure may comprise an array of focussing elements, an array of prismatic surface elements, a diffractive relief structure, a refractive surface relief structure, a reflective surface relief structure and/or a tactile relief structure.

In particularly preferable embodiments, the primary portion of the surface relief structure comprises an array of repeating surface relief elements. For example, the repeating element may be a focussing element or microfocussing element, a diffractive element or a refractive element. In some such cases, the ancillary portion of the surface relief structure does not comprise the repeating surface relief element. Preferably, the second sub-region of the surface region extends away from the first sub-region of the surface region by a distance greater than half of the pitch of the array of repeating surface relief elements, preferably by a distance greater than the pitch of the array of repeating surface relief elements, more preferably by a distance greater than twice the pitch of the array of repeating surface relief elements. This is a preferable method to achieve that the ancillary portion of the surface relief structure extends away from the primary portion of the surface relief structure by a distance greater than half of the pitch of the array of repeating surface relief elements, preferably by a distance greater than the pitch of the array of repeating surface relief elements, more preferably by a distance greater than twice the pitch of the array of repeating surface relief elements. By providing the second sub-region sufficiently large, the ridge-mitigating effect may be improved.

Preferably, the second sub-region of the surface at least partially surrounds the first sub-region of the surface. Further preferably, the second sub-region of the surface entirely surrounds the first sub-region of the surface such that the curable material in the second sub-region of the surface provides a periphery of the curable material across the surface region. The second sub-region of the surface may provide anywhere between one lateral edge of the curable material across the surface region and an entire periphery of the curable material across the surface region. Where an entire periphery is provided, the method may result in a reduction or absence of the ridge of curable material about the entire periphery of the produced security device component. However, in some embodiments, the second region may provide one or more lateral edges or, for example, opposing lateral edges, with the remaining periphery of the security device intended to be removed, for example by cutting, during formation of a final security device.

In some embodiments, the casting relief structure is provided across a casting region of the casting surface, the casting region being larger than the surface region. In these embodiments, the large casting region may entirely prevent a pressure spike that produces the ridging effect while the non-uniform manner in which the curable material is transferred reduces the degree to which the curable material spreads out during casting, maintaining control of the location of the periphery of the security device component.

In other embodiments, the casting relief structure is provided across a casting region of the casting surface, the casting region being smaller than the surface region. In such embodiments, preferably, the casting region is larger than the first sub-region of the surface region, for example, such that all or a portion of the periphery of the casting region is brought into contact with curable material in the second sub-region. In these embodiments, the curable material in the second sub-region may extend beyond the periphery of the casting region, preventing the pressure increase from being focussed at the periphery of the casting region.

In many embodiments, the step of curing the curable material is performed while the casting surface and the support layer are together.

Preferably, the second sub-region of the surface region has a minimum lateral dimension greater than 500 μm, preferably greater than 1000 μm, more preferably greater than 1500 μm. Additionally preferably the second sub-region of the surface region provides at least 1% of the combined area of the first and second sub-regions of the surface region, preferably at least 2%, more preferably at least 4%. These are preferable means of providing that the ancillary portion exhibits these dimensions and relative areas in relation to the primary portion. By providing the second sub-region sufficiently large, the ridge-mitigating effect may be improved.

In accordance with a second aspect of the invention, there is provided a method comprising providing a support layer and a casting relief structure; applying a curable material to a surface across a surface region; wherein the surface is either a surface of the support layer or a casting surface of the casting relief structure; bringing the casting relief structure and the support layer together across the surface region such that the curable material lies therebetween; curing the curable material, thereby fixing a surface relief structure in the cured curable material; and separating the casting relief structure and the support layer such that the cured curable material is carried by the support layer; wherein the casting relief structure is provided across a casting region of the casting surface, the casting region having a first casting sub-region and a second casting sub-region abutting the first casting sub-region, the first casting sub-region and the second casting sub-region defining different relief structures that together define the surface relief structure fixed in the cured curable material and the second casting sub-region providing at least one lateral edge of the casting relief structure, wherein the first casting sub-region defines a primary portion of the surface relief structure and wherein the second casting sub-region defines an ancillary portion of the surface relief structure, the ancillary portion of the surface relief structure having a thickness that decreases from the primary portion of the surface relief structure towards the at least one lateral edge of the surface relief structure.

In this method, the casting relief structure in the casting surface defines an ancillary portion of the surface relief structure that that decreases from the primary portion of the surface relief structure towards the at least one lateral edge of the surface relief structure. This ancillary portion that is actively defined by the casting surface has also been found to reduce the prominence of any ridge of curable material at the at least one lateral edge of the cured curable material, as will be described in more detail below.

In contrast with the method according to the first aspect of the present invention, this method may be performed while applying the curable material to the surface with a substantially constant thickness or in a substantially uniform manner (or with a substantially constant volume per unit area) as the ancillary portion defined by the casting surface provides the mechanism for prevention or reduction of the ridge of cured curable material.

In some embodiments, the casting region is larger than the surface region. In such cases, preferably the first casting sub-region is smaller than the surface region. In these embodiments, the second casting sub-region, which defines the ancillary portion of the surface relief structure, provides a region for excess curable material to expand into. By providing this expansion region as an ancillary region, which may be inconsequential to the design of the final security device component, the primary portion of the surface relief structure may be formed with precise and well defined edges while providing the benefit of reducing the large pressure spikes that produce ridges at the periphery of the component.

In other embodiments, the casting region is smaller than the surface region. In these cases, the second casting sub-region, which defines the ancillary portion of the surface relief structure, does not provide a volume for excess material to expand into, but rather provides that the pressure increase that occurs during casting towards the edge of the casting region is a gradual increase towards the periphery of the casting region, rather than a sharp increase, as with the pressure spikes that cause the ridge of curable material to form. This has been found to significantly reduce the ridging effect described above.

In many embodiments, the first casting sub-region defines an optically active surface relief structure, and the second casting sub-region defines an optically inactive surface relief structure.

The first casting sub-region may define an array of focussing elements, an array of prismatic surface elements, a diffractive relief structure, a refractive surface relief structure, a reflective relief structure and/or a tactile relief structure. Typically, the second casting sub-region will not define an array of focussing elements, an array of prismatic surface elements, a diffractive relief structure, a refractive surface relief structure or a reflective relief structure.

In particularly preferable embodiments, the relief structure of the first casting sub-region comprises an array of repeating surface relief elements. For example, the repeating element may define a focussing element or microfocussing element, a diffractive element or a refractive element. In some such cases, the relief structure of the second casting sub-region does not comprise the repeating surface relief element. Preferably, the second casting sub-region extends away from the first casting sub-region by a distance greater than half of the pitch of the array of repeating surface relief elements, preferably by a distance greater than the pitch of the array of repeating surface relief elements, more preferably by a distance greater than twice the pitch of the array of repeating surface relief elements. This is a preferable method to achieve that the ancillary portion of the surface relief structure extends away from the primary portion of the surface relief structure by a distance greater than half of the pitch of the array of repeating surface relief elements, preferably by a distance greater than the pitch of the array of repeating surface relief elements, more preferably by a distance greater than twice the pitch of the array of repeating surface relief elements. By providing the second sub-region sufficiently large, the ridge-mitigating effect may be improved.

To minimise any pressure spikes, preferably the ancillary portion of the surface relief structure has a thickness that gradually and/or continuously decreases. The ancillary portion of the surface relief structure may have a thickness that gradually decreases in a stepwise manner. In other cases, the ancillary portion may comprise an inclined surface, being either planar or non-planar, or a patterned surface that generally decreases across the second casting sub-region.

Preferably, the second casting sub-region at least partially surrounds the first casting sub-region such that the ancillary portion of the surface relief structure at least partially surrounds the primary portion of the surface relief structure. Further preferably, the second casting sub-region entirely surrounds the first casting sub-region such that the ancillary portion of the surface relief structure entirely surrounds the primary portion of the surface relief structure. The second casting sub-region may provide anywhere between one lateral edge of the casting region and an entire periphery of the casting region. Where an entire periphery is provided, the method may result in a reduction or absence of the ridge of curable material about the entire periphery of the produced security device component. However, in some embodiments, the second casting sub-region may provide one or more lateral edges or, for example, opposing lateral edges, with the remaining periphery of the security device intended to be removed, for example by cutting, during formation of a final security device.

In many embodiments, the step of curing the curable material is performed while the casting surface is in contact with the curable material.

The curable material may generally be applied to the surface using any suitable process. For example, the method may comprise applying the curable material to the surface using a flexographic process, a gravure process, a lithographic process or an intaglio process.

Preferably, the second casting sub-region has a minimum lateral dimension greater than 500 μm, preferably greater than 1000 μm, more preferably greater than 1500 μm. Further, preferably the second casting sub-region provides at least 1% of the combined area of the first and second casting sub-regions, preferably at least 2%, more preferably at least 4%.These are preferable means of providing that the ancillary portion exhibits these dimensions and relative areas in relation to the primary portion. By providing the second casting sub-region sufficiently large, the ridge-mitigating effect may be improved

According to a third aspect of the present invention, there is provided a security device component comprising a layer of cured curable material carrying a surface relief structure in the surface thereof, wherein a first sub-region of the surface relief structure has a first relief structure and a second sub-region of the surface relief structure, abutting the first sub-region, has a second relief structure different from the first relief structure, wherein the first relief structure defines a primary portion of the surface relief structure and the second relief structure defines an ancillary portion of the surface relief structure, the ancillary portion of the surface relief structure having a thickness that decreases from the primary portion of the surface relief structure towards at least one lateral edge of the layer of curable material.

The security device component of the third aspect is suitable for manufacture using either the method of the first or second aspect of the present invention. The security device component has an ancillary portion of the relief structure in its surface that decreases from the primary portion of the surface relief structure towards at least one lateral edge, preferably decreasing up to the lateral edge of the layer of curable material. For the reasons described above, security device components formed with an ancillary portion of this kind will typically have a reduced or completely absent ridge of cured curable material at least at some of the periphery of the layer of cured curable material.

As mentioned in many embodiments, the ancillary portion of the surface relief structure provides the at least one lateral edge of the layer of cured curable material, wherein the ancillary portion of the surface relief structure has a thickness that decreases from the primary portion of the surface relief structure to the at least one lateral edge of the layer of cured curable material.

So that the reduction or absence in the ridge described above is evident about a significant portion of the security device component, preferably the second sub-region of the surface relief structure at least partially surrounds the first sub-region of the surface relief structure. Further preferably, the second sub-region of the surface relief structure entirely surrounds the first sub-region of the surface relief structure and the ancillary portion of the surface relief structure has a thickness that decreases from the primary portion of the surface relief structure towards a periphery of the layer of curable material.

In many embodiments, the ancillary portion of the surface relief structure has a thickness that gradually and/or continuously decreases from the primary portion of the surface relief structure towards the at least one lateral edge of the layer of curable material. The ancillary portion of the surface relief structure has a thickness that gradually decreases in a stepwise manner from the primary portion of the surface relief structure towards the at least one lateral edge of the layer of curable material. In other cases, the ancillary portion may comprise an inclined surface, being either planar or non-planar, or a patterned surface that generally decreases across the second sub-region of the surface relief structure.

Preferably, the primary portion of the surface relief structure is an optically active surface relief structure. Further preferably, the ancillary portion of the surface relief structure is an optically inactive surface relief structure.

In some embodiments, the primary portion of the surface relief structure comprises an array of refractive imaging or focussing elements, an array of reflective imaging elements, an array of (refractive) prismatic surface elements, an array of reflective triangulated structures, a diffractive relief structure, a refractive surface relief structure, a reflective surface relief structure and/or a tactile relief structure. In these embodiments, typically the ancillary portion of the surface relief structure does not comprise an array of focussing elements, an array of prismatic surface elements, a diffractive relief structure, a refractive surface relief structure, or a reflective surface relief structure.

Preferably, the primary portion of the surface relief structure comprises an array of repeating surface relief elements. For example, the repeating element may be a focussing element or microfocussing element, a diffractive element or a refractive element. Typically, in these cases, the ancillary portion of the surface relief structure does not comprise the repeating surface relief element. Preferably, the ancillary portion of the surface relief structure extends away from the primary portion of the surface relief structure by a distance greater than half of the pitch of the array of repeating surface relief elements, preferably by a distance greater than the pitch of the array of repeating surface relief elements, more preferably by a distance greater than twice the pitch of the array of repeating surface relief elements. By providing the ancillary portion sufficiently large, the ridge-mitigating effect may be improved

As described above with respect to the first aspect, the ancillary portion may be formed by reducing the volume per unit area of the curable material towards a periphery of the curable material. In some cases, this intentionally results in incomplete formation of the surface relief structure in the ancillary region, thereby providing a gradual decrease in height towards the lateral edge. The result in the produced security device component may be that the ancillary portion of the surface relief structure comprises at least one incomplete version of the repeating surface relief element. The ancillary region may comprise successively more incomplete versions of the repeating surface relief element.

As mentioned, the security device component may not exhibit any ridge of curable material at the at least one lateral edge. However, in other some cases, the security device component may only exhibit a reduction in the ridge of curable material. Therefore, in some cases, the security device component comprises a ridge of the cured curable material along at least a portion of a periphery of the layer of cured curable material, wherein the ridge of cured curable material has a maximum height that is less than a maximum height of the primary portion of the surface relief structure. In these cases, preferably the ancillary portion of the surface relief structure has a thickness that decreases from the primary portion of the surface relief structure to the ridge of the cured curable material.

Preferably, the ancillary portion of the surface relief structure has a minimum lateral dimension greater than 500 μm, preferably greater than 1000 μm, more preferably greater than 1500 μm. Further, preferably, the ancillary portion of the surface relief structure provides at least 1% of the combined area of the primary and ancillary portions of the relief structure, preferably at least 2%, more preferably at least 4%. Again, a relatively large ancillary portion improves the mitigation of the ridge of cured curable material.

### BRIEF DESCRIPTION OF THE DRAWINGS

Some examples of methods and devices according to the invention will now be described and contrasted with conventional methods and devices, with reference to the accompanying drawings, in which:

FIGS. 1A and 1B show, schematically, first and second known systems for forming a security device component;

FIGS. 2A and 2B show, schematically and in cross-sectional views, an enlarged portion of the first known system and the resulting security device component respectively;

FIGS. 3A to 3E show, schematically and in cross-sectional views, a curable material application device suitable for use in a method according to a first embodiment of the invention at five different stages during use;

FIGS. 4A and 4B show, schematically and in cross-sectional views, a portion of a system for implementing the method according to the first embodiment of the invention and the resulting security device component according to the invention;

FIGS. 5A to 5C show, schematically and in cross-sectional views, a curable material application device suitable for use in a method according to a second embodiment of the invention at three different stages during use;

FIGS. 6A and 6B show, schematically and in cross-sectional views, a portion of a system for implementing the method according to the second embodiment of the invention and the resulting security device component according to the invention;

FIGS. 7A to 7C show, schematically and in cross-sectional views, a curable material application device suitable for use in a method according to a third embodiment of the invention at three different stages during use;

FIGS. 8A and 8B show, schematically and in cross-sectional views, a portion of a system suitable for implementing a method according to a fourth embodiment and the final security device component respectively;

FIGS. 9A and 9B show, schematically and in cross-sectional views, a portion of a system suitable for implementing a method according to a fifth embodiment and the final security device component respectively;

FIG. 10 shows, schematically and in cross-sectional view, an alternative casting surface for use in a method according to a sixth embodiment; and

FIG. 11 shows, schematically and in cross-sectional view, a further alternative casting surface for use in a method according to a seventh embodiment.

### DETAILED DESCRIPTION

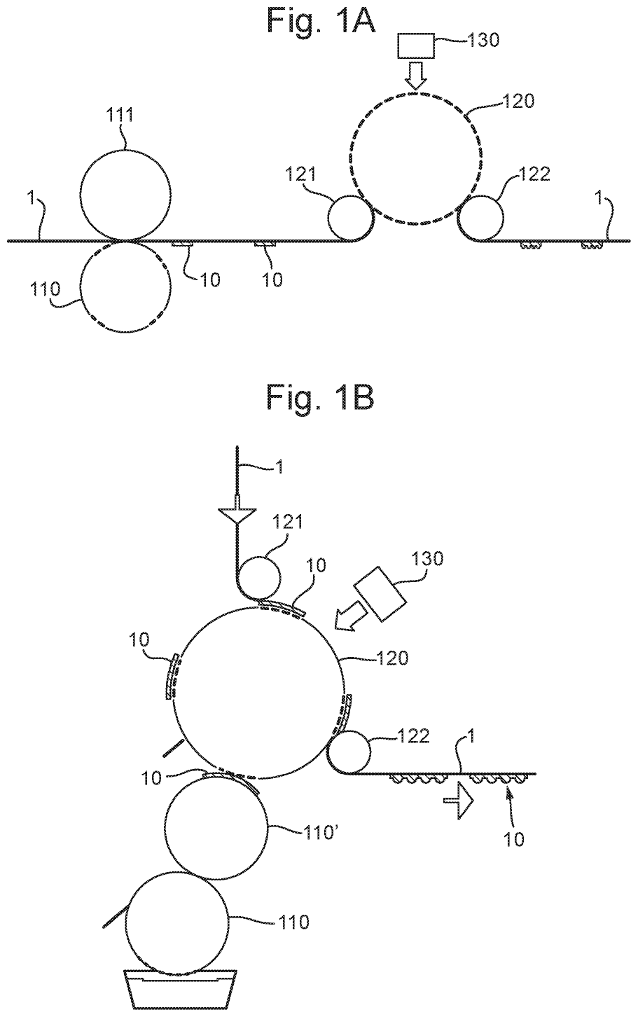

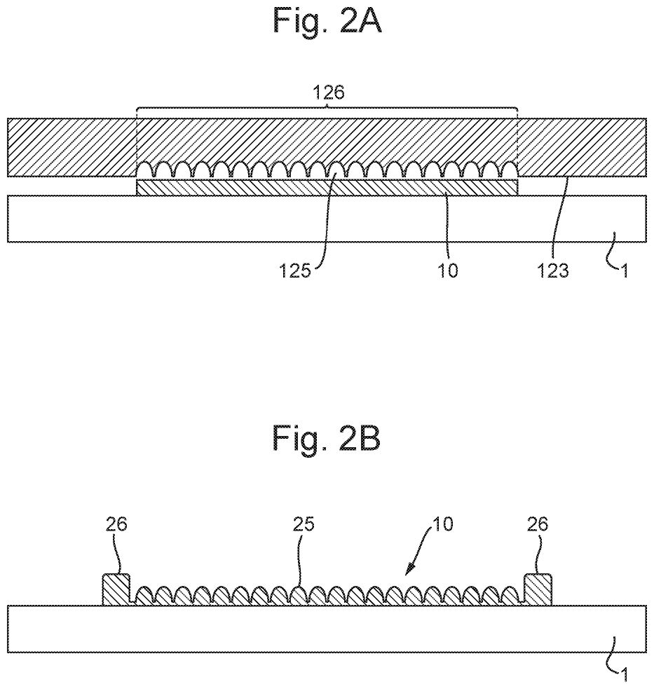

FIGS. 1A to 2B show known systems for forming a security device component and the security device component produced using this system, as has been mentioned above.

As shown in FIG. 1A, a typical system for implementing a method of security device component manufacture comprises support layer as a web of support material 1 that is conveyed through the system by a number of rollers 110, 111, 120, 121, 122. The web of support material may be a web of polyethylene terephthalate (PET), biaxially oriented polypropylene (BOPP) or less typically polyethylene terephthalate glycol-modified (PET-G) or polyvinyl chloride (PVC) with a thickness in the range of 12 μm to 150 μm but more typically in the range 15 μm to 80 μm. A patch of curable material 10 is applied onto the web of support material 1 by a gravure roller 110, working in cooperation with an impression roller 111, although other application systems known in the art are also widely used. The web of support material 1 is fed through a nip defined between the gravure roller 110 and the impression roller 111. In this nip, the support material is pressed against the surface of the gravure roller 110 and receives a patch of curable material 10 carried on the surface of the gravure roller. The patch of curable material 10 is received on the web of support material 1 substantially continuously and uniformly in a support layer region (surface region).

Suitable curable materials include radiation-curable materials and may comprise a resin which may typically be of one of two types, namely:

a) Free radical cure resins, which are typically unsaturated resins or monomers, pre-polymers, oligomers etc. containing vinyl or acrylate unsaturation for example and which cross-link through use of a photo initiator activated by the radiation source employed e.g. UV.

b) Cationic cure resins, in which ring opening (e.g. epoxy types) is effected using photo initiators or catalysts which generate ionic entities under the radiation source employed e.g. UV. The ring opening is followed by intermolecular cross-linking.

The radiation used to effect curing will typically be UV radiation but could comprise electron beam, visible, or even infra-red or higher wavelength radiation, depending upon the material, its absorbance and the process used. Examples of suitable curable materials include UV curable acrylic based clear embossing lacquers or those based on other compounds such as nitro-cellulose. A suitable UV curable lacquer is the product UVF-203 from Kingfisher Ink Limited or photopolymer NOA61 available from Norland Products. Inc., New Jersey.

The curable material could be elastomeric and therefore of increased flexibility. An example of a suitable elastomeric curable material is aliphatic urethane acrylate (with suitable cross-linking additive such as polyaziridine).

The web of support material 1, together with the patch of curable material 10, is then fed towards the rollers involved in the cast-cure process 120, 121, 122. A second impression roller 121 receives the web of support material 1 and presses it against a casting cylinder 120 at a nip defined between the second impression roller 121 and the casting cylinder 120. At this nip between the second impression roller 121 and the casting cylinder 120, a casting relief structure 125 (shown in FIG. 2A) that is formed in a casting surface 123 of the casting cylinder 120 is pressed into the patch of curable material 10. The casting relief structure 125 is provided across a casting region 126 that substantially matches the support layer region, across which the patch of curable material is disposed. As the casting relief structure 125 is pressed into the curable material, the curable material deforms to match the casting relief structure 125, thereby providing the surface of the curable material 10 with a surface relief structure 25. So that the curable material completely fills the casting relief structure, it typically has a thickness that is approximately the same as the maximum depth of the casting relief structure. As a result, the volume of curable material is typically greater than the volume of the casting relief structure. This discrepancy in volumes and the excess curable material causes a pressure spike at the edge of the casting region 126. As has been mentioned above, it has been found by the present inventor that this pressure spike causes the web of support material 1 and/or the surface of the second impression roller 121 to deform, and excess curable material to escape the casting region 126 and fill the volume of the deformation.

From the nip between the second impression roller 121, the web of support material 1 wraps around the casting cylinder 120, thereby holding it in contact with the casting cylinder 120. While in contact with the casting cylinder 120, the curable material is cured by exposure to curing radiation, thereby fixing the surface relief structure 25 in the curable material 10. In this case, the curable material is a UV-curable material and is exposed to a UV light source 130, either through a transparent casting cylinder or through a transparent web of support material 1. The excess curable material that is pushed out of the casting region 126, causing the deformation of the web of support material 1 or impression roller 121, is cured together with the rest of the curable material.

The web of substrate continues to wrap around the casting cylinder 120 until it reaches roller 122, which removes the web of material from the casting cylinder 120 and conveys it on to further processing (not shown). Once the curable material and support material is removed from the surface of the casting cylinder 120, at least some of the deformation in the support material 1 is reversed, resulting in a ridge of cured curable material 26 existing about the periphery of the surface relief structure 25 in the cured curable material 10, this ridge standing proud of the surface of the web of support material and extending above the surface relief structure 25.

FIG. 1B shows an alternative known system in which the curable material is applied directly onto the casting cylinder 120. In this system, a gravure roller 110 receives a patch of curable material 10 in a conventional manner and transfers the patch of curable material onto an optional transfer roller 110′. The transfer roller then brings the patch of curable material 10 in contact with the casting cylinder 120 and transfers the curable material onto the casting cylinder across the casting relief structure 125 in a casting surface region (surface region). The casting cylinder 120 rotates, bringing the patch of curable material 10 towards a point at which the web of support material 1 is brought in contact with the casting cylinder 120. At this point, the web of support material 1 is fed through a nip between the casting cylinder 120 and an impression roller 121. When the curable material 10 is fed through this nip between the casting cylinder 120 and the impression roller 121, it is pressed between the casting relief structure 125 and the web of support material 1 across the casting surface region, thereby causing it to conform to the casting relief structure 125. The curable material is then cured by exposure to curing radiation while in contact with the casting relief structure 125, fixing the surface relief structure 25 in its surface. Finally, the cured curable material 10 is separated from casting cylinder by a roller 122 such that it is carried away on the surface of the web of support material 1.

The below description of embodiments of the invention will focus on methods in which the curable material is applied to the web of support material before being brought into contact with the casting cylinder. However, it will be appreciated that any teachings apply equally to embodiments in which the curable material is applied directly onto the casting surface, as in FIG. 1B.

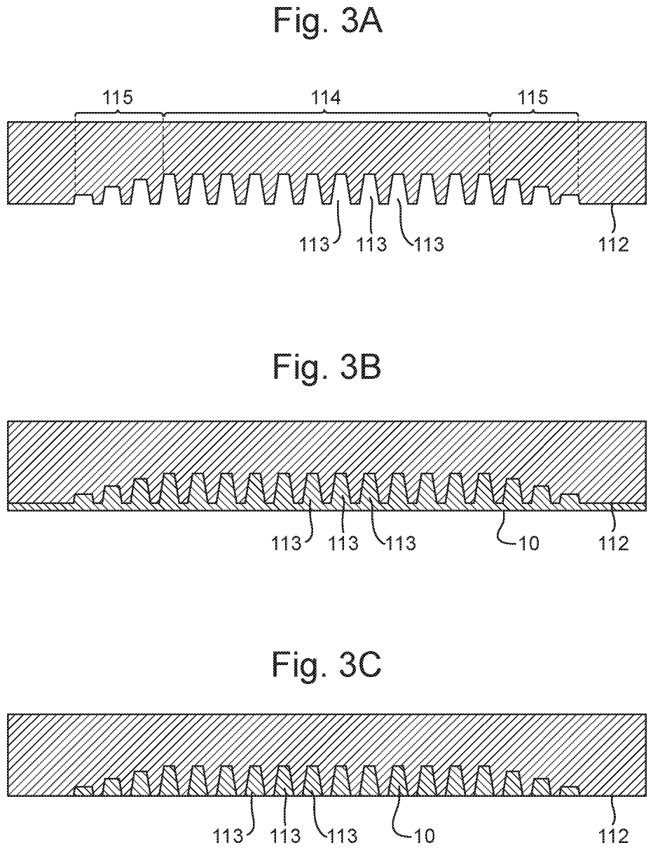

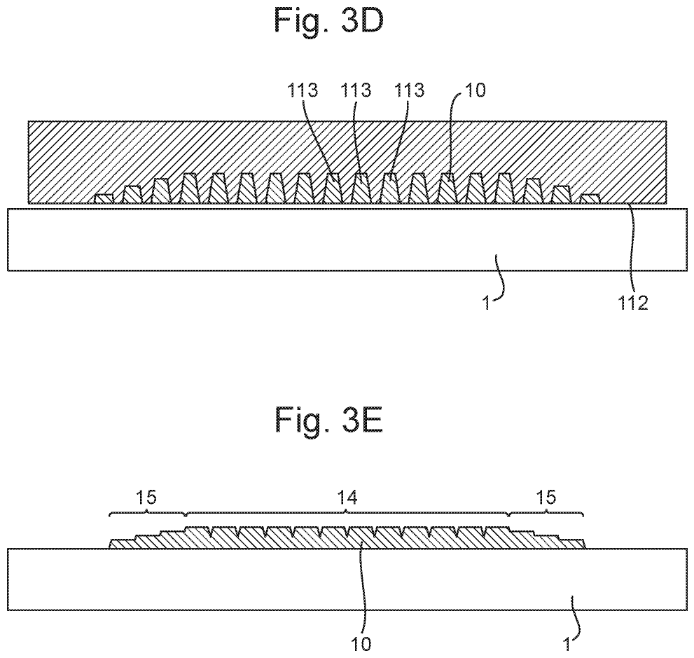

A method of forming a security device component according to a first embodiment of the present invention will now be described in detail with reference to FIGS. 3A to 4B.

In this method, formation of a ridge of curable material is reduced or eliminated by applying the curable material onto the web of support material 1 with a volume per unit area that decreases towards the edge of the curable material patch. This is achieved by replacing the standard gravure roller 110 of a system consistent with FIG. 1A with an application device configured to transfer material with varying volume per unit area. Part of an application device so configured is shown in FIGS. 3A to 3E.

FIG. 3A shows a part of a gravure cylinder 110 that has been adapted to transfer curable material with varying volume per unit area. The gravure cylinder comprises an application surface 112 having an array of recesses 113 formed therein. The recesses are provided across first and second application surface sub-regions 114, 115, which together define an application surface region. The first application surface sub-region 114 makes up a central portion of the application surface region, while the second application surface sub-region 115 makes up a perimeter portion of the application surface region.

The recesses 113 located in the first application surface sub-region 114, i.e. the central portion, each have substantially the same shape and size so as to have equal volume. Additionally, these recesses are uniformly distributed across the sub-region.

The recesses 113 located in the second application surface sub-region 115, i.e. the perimeter portion, have a depth that decreases from the first application surface sub-region 114 to the perimeter of the application surface region, i.e. they decrease in volume towards the perimeter of the array of recesses.

FIG. 3B shows the application surface 112 after it has been coated with the curable material 10. The curable material 10 coats the entire application surface 112 and is received in the recesses 113. While the material may be transferred on to the web of support material in this form, in this embodiment, excess curable material, i.e. material not located in the recesses 113, is removed from the application surface 112 using a wiping process, for example, using a doctor blade (not shown). The result, as shown in FIG. 3C, is curable material located only within each of the recesses.

FIG. 3D shows the application surface 112 being brought into contact with the web of support material 1, which is analogous to the application of curable material at the gravure cylinder 110 in FIG. 1A. As in the FIG. 1A system, the web is pressed against the application surface 112 such that the curable material is transferred onto the web of support material 1.

FIG. 3E shows the patch of uncured curable material 10 received on the web of support material 1. The curable material 10 is received on the support material 1 in a support layer region (surface region) 14, 15. In a first support layer sub-region (first surface sub-region) 14, which corresponds to material received from recesses in the first application surface sub-region 114, the curable material has a first, generally constant volume per unit area owing to the equal volume and spacing of the recesses 113 in the first application surface sub-region 114. In a second support layer sub-region (second surface sub-region) 15, which corresponds to material received from recesses in the second application surface sub-region 115, the curable material has a volume per unit area that is lower than the volume per unit area in the first sub-region 14 and that, in this case, decreases towards the periphery of the layer of curable material owing to the decreasing volume of the recesses across the second application surface sub-region 115. The resulting patch of curable material has a higher volume per unit area in the central first support layer sub-region than in the perimeter region provided by the second support layer sub-region, with the volume per unit area in this perimeter region decreasing towards the edge of the patch of curable material.

FIG. 4A shows the web of support material 1 and the patch of curable material 10 as it is brought into contact with the casting surface 123 of a casting cylinder 120, which may be done in substantially the manner described above with respect to FIGS. 1 and 2A, i.e. using the casting cylinder 120 and impression roller 121. In this embodiment, the casting relief structure 125 is provided in a casting region 126 that is smaller than the support layer region made up by the first and second support layer sub-regions 14, 15 described above. The edges of the casting relief structure 125 are thereby brought into contact with curable material in the second support layer sub-region 15, with the curable material continuing slightly beyond the edges of the casting relief structure 125. As the curable material 10 in the first support layer sub-region 14 is cast and brought into conformity with the casting relief structure 125, excess curable material is pushed towards the periphery of the casting relief structure 125. Since a periphery region of the casting relief structure is cast into curable material 10 in the second support layer sub-region, which is essentially under filled owing to the lower volume per unit area of curable material, this excess curable material may contribute to filling the casting relief structure 125 near the periphery of the casting region 126. Additionally, since the curable material 10 gradually decreases and extends beyond the periphery of the casting relief structure 125, it provides a mechanism for preventing a pressure spike occurring at the periphery of the casting relief structure 125, allowing for excess curable material to be distributed over a larger area outside of the casting region.

The resulting security device component is shown in FIG. 4B, i.e. after curing and separating from the casting cylinder in a manner as described above with respect to FIGS. 1 and 2A. As can be seen from the Figure, the result is a relief structure primary portion 25 in a central region of the cured curable material 10 that corresponds to the relief structure provided in the casting surface 123, in this case an array of microlenses. Additionally, providing the curable material in the manner described above results in a relief structure ancillary portion 24 being formed about the periphery of this primary relief structure portion 25, instead of a tall ridge of curable material. This ancillary portion 24 has a thickness that decreases from the primary portion of the relief structure 25 towards a lateral edge of the cured curable material. This ancillary portion is optically inactive, unlike the microlenses in the primary portion of the relief structure 25.

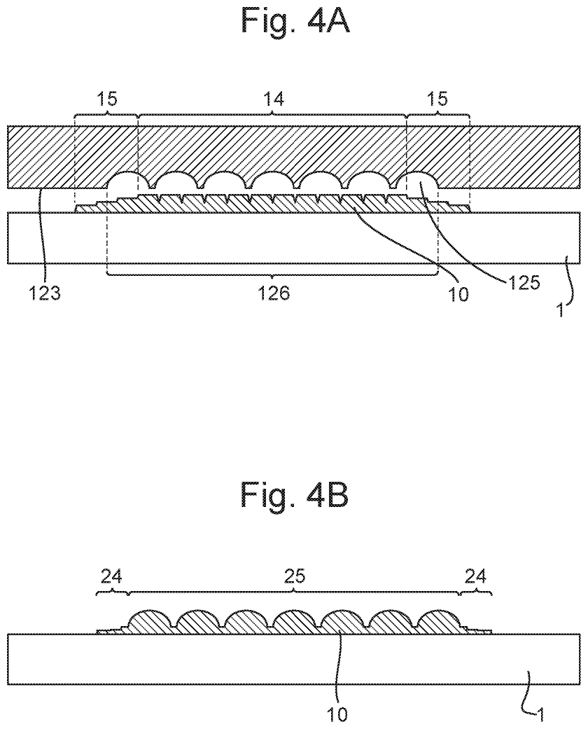

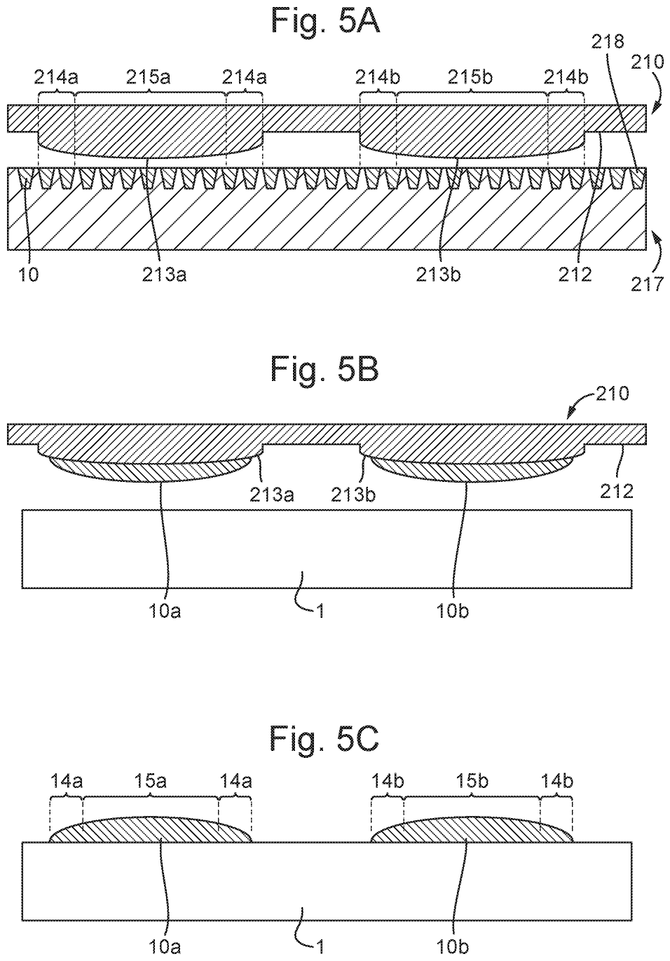

A second embodiment of a method according to the invention will now be described with reference to FIGS. 5A to 6B.

FIGS. 5A to 5C show an application device configured to transfer curable material onto a web of support material 1 with a volume per unit area that decreases towards the edges of the layer of curable material 10.

In this embodiment, the standard gravure roller 110 of a system consistent with FIG. 1A is replaced with an application system comprising a flexographic application cylinder 210. The flexographic application cylinder 210 has an application surface 212. Raised above the application surface 212 are first and second surface reliefs 213a, 213b. Each surface relief is provided across respective first and second application surface regions 214a, 215a, 214b, 215b. While the present embodiment utilises two raised surface reliefs for applying material in two discrete patches 10a, 10b, any number of raised surface reliefs could be used.

Each surface relief 213a, 213b comprises a pedestal projecting from the application surface 212, the pedestal having a gently domed surface in profile, however its shape in plan view may be any shape. A central, first application surface region 215a, 215b corresponds to the highest and most central region of the domed surface relief 213a, 213b. A second application surface region 214a, 214b makes up the remaining perimeter region of the domed surface relief 213a, 213b, and therefore comprises the lower areas of the domed surface relief.

The flexographic application cylinder 210 is pressed against a source of curable material in order to coat the domed surface reliefs 213a, 213b in curable material 10. In this embodiment, the source of curable material comprises a gravure cylinder 217 comprising a uniform array of equally sized and equally spaced recesses 218 containing curable material 10. When the application surface 212 of the flexographic application cylinder 210 is pressed against the gravure cylinder 217, only the domed surface reliefs 213a, 213b come into contact with the curable material in the recesses 218. The contact pressure between each domed surface relief 213a, 213b and the gravure cylinder 217 varies across the domed surface relief 213a, 213b in accordance with the height of the domed surface relief. The first application surface region 215a, 215b, having the central and higher area of each domed surface relief 213a, 213b, contacts the gravure cylinder 217 with a higher contact pressure than the second application surface region 214a, 214b, which has the lower perimeter area of each domed surface relief 213a, 213b. As a result, the first application surface region 215a, 215b receives the curable material 10 having a higher volume per unit area than the second application surface region 214a, 214b. Specifically, in this embodiment, the curable material forms a dome shaped patch of curable material on the domed surface reliefs 213a, 213b and this is shown in FIG. 5B.

The curable material 10 on the flexographic application cylinder 210 is then transferred onto the web of support material 1. This is done by bringing the application surface of the flexographic application cylinder 210 in contact with the web of curable material, e.g. at a nip between the flexographic application cylinder and an impression roller 111, such that the curable material 10 on each surface relief 213a, 213b is pressed against the web of support material 1. The resulting patches 10a, 10b of curable material are shown in FIG. 5C.

The curable material 10 is transferred onto the web of support material 1 in first and second patches 10a, 10b across respective support layer regions (surface regions) 14a, 14b, 15a, 15b having the same material distribution as on the surface relief 213a, 213b, i.e. the patches of curable material are substantially dome shaped. Each patch of curable material 10 has a central, first support layer sub-region 15a, 15b, in which the curable material has a first average volume per unit area, and a second perimeter support layer sub-region 14a, 14b, in which the curable material has a second, lower average volume per unit area. More specifically, the first support layer sub-region (first surface sub-region) has the thicker central area of the dome of curable material while in the second support layer sub-region (second surface sub-region) 14a, 14b, which provides the perimeter of the layers of curable material 10a 10b, the curable material tapers down in height from a maximum abutting first support layer sub-region 15a, 15b to zero thickness at the edge of the layer of curable material 10a 10b.

FIGS. 6A and 6B show the patches of curable material shown in FIG. 5C before and after they are brought into contact with the casting surface 123 of a casting cylinder 120, which may be done in substantially the manner described above with respect to FIGS. 1 and 2A, i.e. using the casting cylinder 120 and impression roller 121. In this embodiment, the casting relief structure 125 is provided across first and second casting regions 126a, 126b that correspond to the first and second patches of curable material 10a, 10b. The first and second casting regions 126a, 126b are larger than the first and second support layer regions 14a, 15a, 14b, 15b, which have the patches of curable and extend beyond the first and second support layer regions in all directions. The first and second casting regions 126a, 126b meet one another at a centre point between the first support layer region 14a, 15a (having the first patch of curable material 10a) and the second support layer region 14b, 15b (having the second patch of curable material 10b).

As the casting relief structure 125 of the casting surface 123 is brought into contact with the curable material 10, the curable material is deformed in accordance with the casting relief structure 125. The curable material in the first support layer sub-regions 15a, 15b is generally provided with a volume per unit area great enough that the casting relief structure 125 is completely conformed to resulting in a complete primary portion 25a, 25b of each layer of cured curable material 10a, 10b. The curable material in the second support layer sub-regions 14a, 14b, however, has a volume per unit area that is lower than in the first support layer sub-regions 15a, 15b and that decreases towards the perimeter of the resin patch. The curable material in these regions, therefore, does not completely conform to the relief casting relief structure 125, even when accounting for excess curable material from the first support layer sub-regions 15a, 15b. The result, in this case, is incomplete and consequently non-functioning microlenses in an ancillary region 24a, 24b, those incomplete lenses gradually decreasing in height towards the periphery of the layer of cured curable material 10a, 10b.

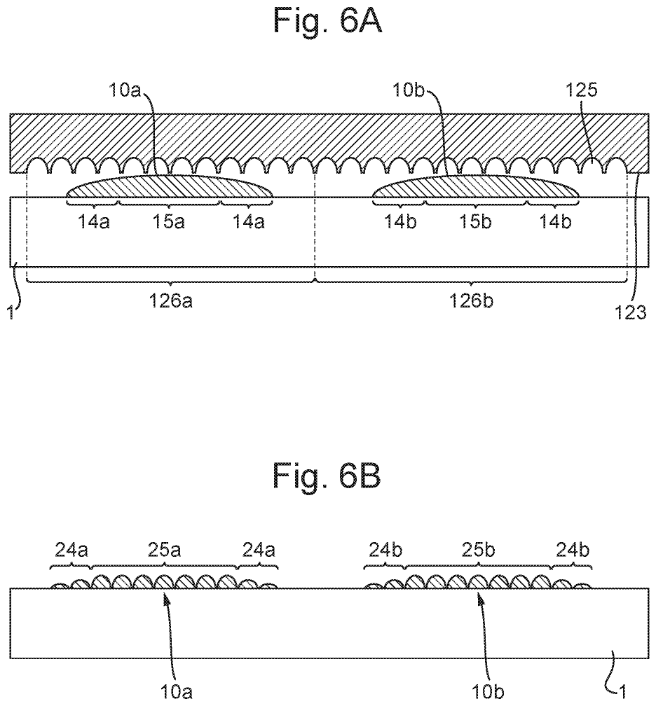

A third embodiment of a method according to the invention will now be described with reference to FIGS. 7A to 7C. These Figures show an application device configured to transfer curable material onto a web of support material 1 with a volume per unit area that decreases towards the edges of the layer of curable material 10.

In this embodiment, the standard gravure roller 110 of a system consistent with FIG. 1A is replaced with an application system comprising a flexographic application cylinder 310. The flexographic application cylinder 310 has an application surface 312. Raised above the application surface is a relief structure 313. The surface relief 313 is provided across first and second application surface sub-regions 315, 314, which together constitute the application surface region, from which curable material is applied.

The surface relief is formed of an array of projections, each having a substantially flat upper surface and each projection being of substantially the same height. In a central, first application surface sub-region 315, the projections make up a first proportion of the total area of the first application surface region 315. In a second application surface sub-region 314, which forms a perimeter area of the application surface region, the projections make up a second proportion of the total area of the second application surface sub-region 314, the second proportion being lower than the first. Further, in the second application surface sub-region 314, the coverage provided by these projections decreases towards the perimeter of the application surface region.

The flexographic application cylinder 310 is pressed against a source of curable material, which is substantially as described above with respect to the second embodiment, in order to coat the application surface relief 313 in curable material. Here, each projection receives a coating of curable material having substantially the same thickness. The difference in the area the projections cover within the first and second application surface sub-regions provides these regions with a different average volume per unit area of the curable material 10. Further, in the second application surface sub-region 314, the volume per unit area of the curable material 10 decreases towards the perimeter of the application surface region owing to the decreasing coverage provided by the projections.

The curable material 10 is transferred onto the web of support material 1 substantially as described above with respect to the second embodiment. The resulting patch of curable material 10 is shown in FIGS. 7C. As shown, the curable material is transferred onto the web of support material 1 having the same volume per unit area with which it was received on the application surface relief 313, i.e. the curable material 10 is received in a central first support layer sub-region 15 having a greater volume per unit area than that with which it is received in a second support layer sub-region 14, the second support layer sub-region providing a perimeter of the layer of curable material.

This patch of curable material 10 may then be cast into, as described above with respect to either of the first or second embodiments of the invention.

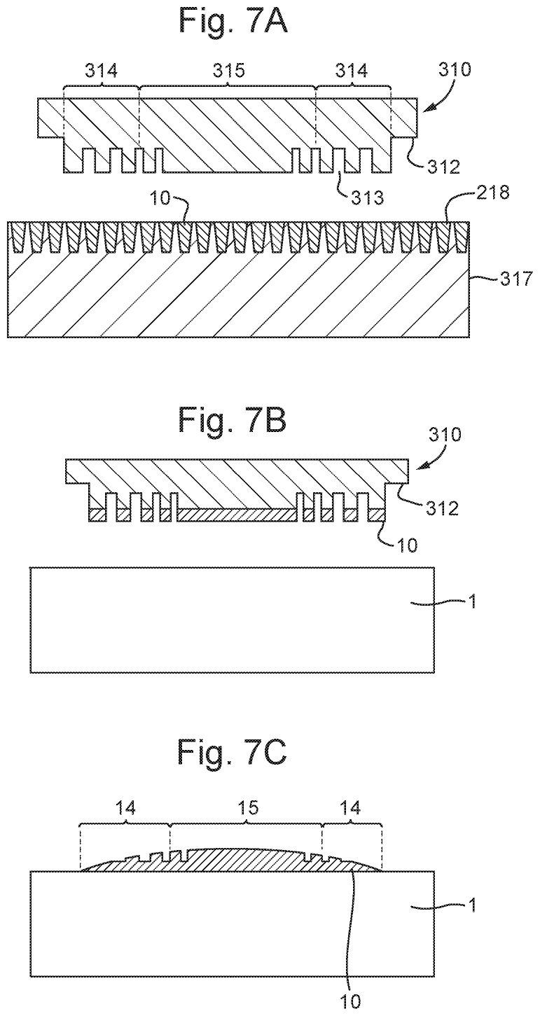

A fourth embodiment will now be described with reference to FIGS. 8A and 8B. In this method, formation of a ridge of curable material is reduced or eliminated by providing the casting surface with an ancillary region of the casting relief that prevents the large pressure spikes seen in known systems. Accordingly, a system for implementing this method may be one consistent with FIG. 1A with a casting cylinder adapted according to the below.

FIG. 8A shows the surface of a casting cylinder 220 adapted according to the invention. This casting cylinder comprises a casting surface 223 into which is formed a casting relief structure 225. The casting relief structure 225 is provided across a casting region composed of a first casting sub-region 227 and a second casting sub-region 228. The first casting sub-region 227 makes up a central portion of the casting region, while the second casting sub-region 228 makes up an outer perimeter portion of the casting region.

The casting relief structure 225 in the first casting sub-region 227 defines a primary portion of the surface relief intended for the final security device component. In this case, the first casting sub-region 227 defines an array of spherical microlenses; however, any desired relief structure may be used.

The casting relief structure 225 in the second casting sub-region 228 defines an ancillary portion of the surface relief intended for the final security device component. This ancillary portion provides the mechanism by which the ridge of curable material is reduced or eliminated, as will be described below. In the present case, the casting relief structure 225 in the second casting sub-region 228 defines a stepwise height or thickness reduction from the first casting sub-region 227 to the periphery of the casting region. While a stepwise height reduction is used here, any form of graduated reduction may be used to graduate the change from the casting relief structure 225 in the first casting sub-region 227 to the flat casting surface outside of the casting region.

As shown in FIG. 8A, the casting cylinder 220 is brought into contact with curable material 10 provided across the web of support material 1, which may be done substantially as described with respect to FIGS. 1 to 2A. In this embodiment, the curable material 10 is provided across an area (support layer region) that is larger than the casting region defined in the casting cylinder 220. As the casting relief structure 225 is brought into contact with the curable material 10, the curable material conforms to the shape of the casting relief structure 225. Any excess material is pushed towards the periphery of the casting region. However, the graduated change in height provided by casting relief structure 225 in the second casting sub-region 228 ensures that there is no large pressure spike, and instead the pressure increases gradually towards the periphery of the casting region. This ensures that any deformation of the web of support material or the impression roller 121 is a small deformation over a large area, replacing the large deformation confined to small areas observed in the known methods and systems that suffer from ridges in the cured curable material.

The resulting security device component is shown in FIG. 8B. The security device component carries in its surface a surface relief structure 24, 25. A primary portion of the surface relief structure 25 is provided in a central region of the layer of cured curable material and corresponds to the casting relief structure 225 in the first casting sub-region 227 of the casting surface 223. Accordingly, the primary portion of the surface relief structure 25 is an array of microlenses. An ancillary portion of the surface relief structure 24 is provided in a perimeter region of the layer or cured curable material 10, the ancillary portion corresponding to the casting relief structure 225 in the second casting sub-region 228 of the casting surface 223. The ancillary portion of the surface relief structure 24 therefore exhibits a stepwise decrease in thickness towards the perimeter of the layer of cured curable material 10. This ancillary portion is optically inactive, unlike the microlenses in the primary portion of the relief structure 25.

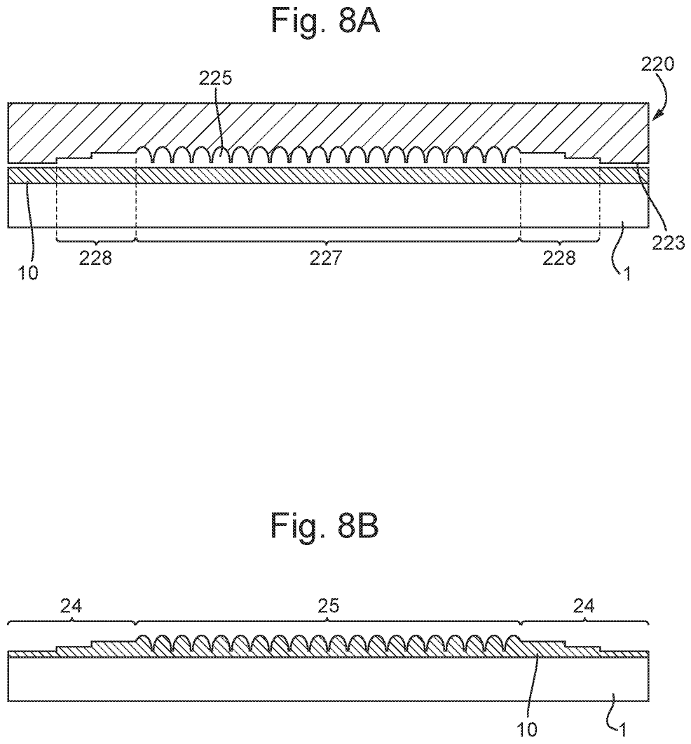

A fifth embodiment will now be described with reference to FIGS. 9A and 9B.

In the method according to this embodiment, the same casting cylinder 220 is used, having the same casting relief structure 225 located across a casting region defined by the central first casting sub-region 227 and the perimeter second casting sub-region 228. In this embodiment, however, the layer of curable material is applied to the web of curable material 1 such that the patch of curable material 10 is smaller than the casting region, across which the surface relief 225 is formed. In particular, the patch of curable material 10 is larger than central first casting sub-region 227, but does not extend beyond the boundary of the second casting sub-region 228.

In the present method, when the curable material 10 on the web of support material 1 is brought into contact with the casting relief structure 225 in the casting surface 223, the curable material pressed into the first casting sub-region 227 conforms to form a primary portion of the relief structure, which again is an array of microlenses. Any excess material is pushed towards the periphery of the casting region. In this case, as the casting region is larger than the initial patch of curable material, the ancillary portion defined by the relief structure in the second casting sub-region 228 provides an area for excess material to expand into, thereby providing a mechanism for alleviating the above-described pressure spike. Additionally, even if the excess curable material does fill the casting relief structure 225 in the second casting sub-region 228, the graduated transition from the primary portion of the casting relief 225 in the first casting sub-region 227 to the perimeter of the second casting sub-region 228 acts to distribute the pressure increase over a wider area, mitigating even further the pressure spike observed in known systems.

A security device component according to this embodiment is shown in FIG. 9B. As with the security device of FIG. 8B, this security device component carries in its surface a surface relief structure 24, 25. A primary portion of the surface relief structure 25 is provided in a central region of the layer of cured curable material and corresponds to the casting relief structure 225 in the first casting sub-region 227 of the casting surface 223. Accordingly, the primary portion of the surface relief structure 25 is an array of microlenses. An ancillary portion of the surface relief structure 24 is provided in a perimeter region of the layer or cured curable material 10, the ancillary portion corresponding to the casting relief structure 225 in the second casting sub-region 228 of the casting surface 223, at least in as far as the excess curable material was sufficient to completely fill the casting relief structure 225 in the second casting sub-region 228. The ancillary portion of the surface relief structure 24 therefore exhibits a stepwise decrease in thickness up to the perimeter of the layer of cured curable material 10, which approximately corresponds to the perimeter of the casting region in this embodiment. Again, this ancillary portion is optically inactive, unlike the microlenses in the primary portion of the relief structure 25.

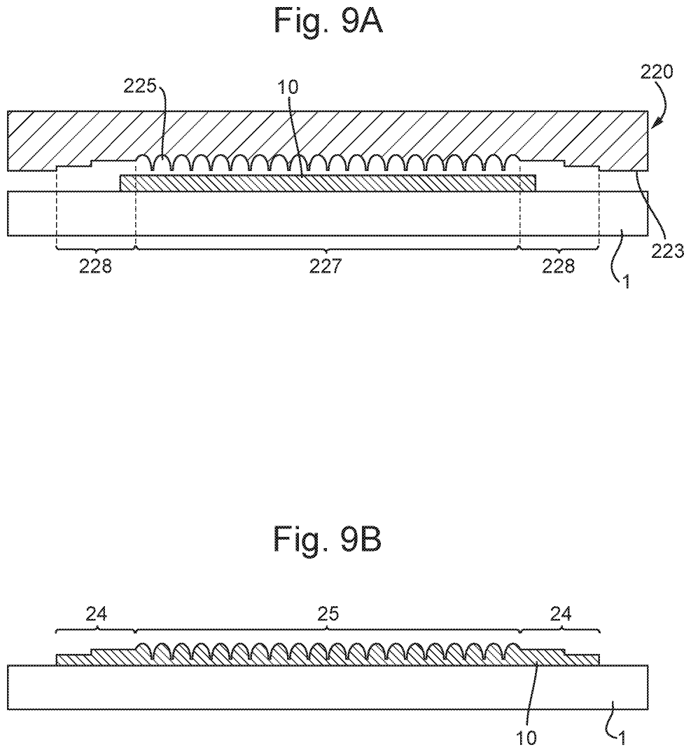

An alternative casting relief structure 225 is shown in FIG. 10. The casting relief according to this sixth embodiment may be implemented in a method otherwise identical with either the fourth of fifth embodiments. In this embodiment, the casting relief structure 225 in the casting surface 223 of the casting cylinder 220 comprises a first casting sub-region 227 and a second casting sub-region 228. The first casting sub-region 227 makes up a central portion of the casting region, while the second casting sub-region 228 makes up an outer perimeter portion of the casting region.

The casting relief structure 225 in the first casting sub-region 227 defines a primary portion of the surface relief intended for the final security device component. In this case, the first casting sub-region 228 is shown as defining an array of spherical microlenses.

The casting relief structure 225 in the second casting sub-region 228 defines an ancillary portion of the surface relief intended for the final security device component. Again, this ancillary portion provides the mechanism by which the ridge of curable material is reduced or eliminated, i.e. the mechanisms described above with respect to the fourth and fifth embodiments. In this embodiment, the ancillary portion of the surface relief structure defined in the second casting sub-region 228 is a series of microlenses of gradually decreasing height, i.e. lenses whose height decreases from the first casting sub-region 227 to the periphery of the casting relief structure 225. These elements of the second casting sub-region may be optically active, e.g. they may focus light and optionally may define a focal plane substantially coincident with the focal plane defined by the microlenses of the first casting sub-region 227 (although the reduced height will typically result in a narrower operating angle).

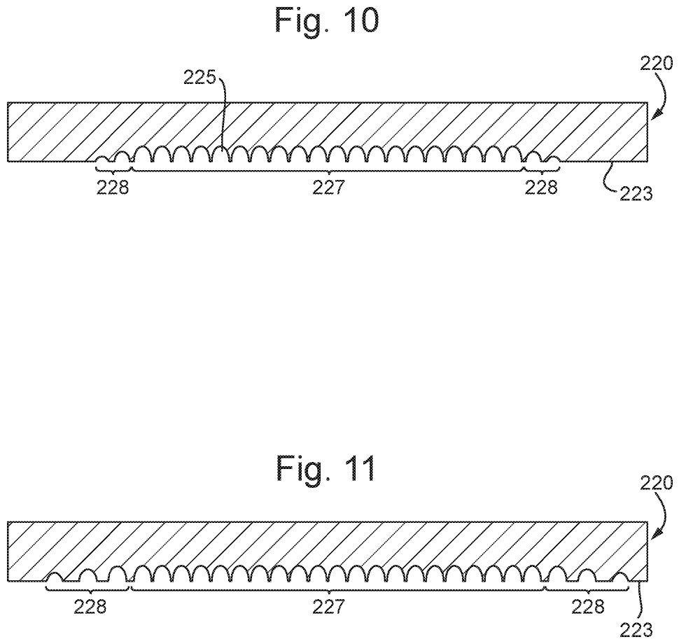

A second alternative is shown in FIG. 11. The casting relief according to this seventh embodiment may again be implemented in a method otherwise identical with either the fourth of fifth embodiments. The first casting sub-region 227 is identical to the first casting sub-region of the sixth embodiment. However, the second casting sub-region 228, which again is arranged as an outer perimeter portion of the casting region, defines a series of microlenses that both reduce in height towards the periphery of the casting region and are spaced at greater intervals than the lenses in the first casting sub-region 227. This increased spacing of the elements of the second casting sub-region 228 increases the area over which the pressure build-up is distributed, thereby reducing the tendency for pressure spikes that cause a ridge of curable material to form.

1-64. (canceled)

65. A method of forming a security device component comprising:
providing a support layer and a casting relief structure;
applying a curable material to a surface across a surface region thereof using an application device, the application device being adapted to transfer the curable material onto the surface in a first sub-region of the surface region with a first average volume per unit area and to transfer the material onto the surface in a second sub-region of the surface region with a second average volume per unit area, wherein the curable material in the second sub-region abuts the curable material in the first sub-region, wherein the curable material in the second sub-region provides at least one lateral edge of the curable material across the surface region, and wherein the second average volume per unit area is less than the first average volume per unit area;
wherein the surface is either a surface of the support layer or a casting surface of the casting relief structure;
bringing the casting relief structure and the support layer together across the surface region such that the curable material lays therebetween;
curing the curable material, thereby fixing a surface relief structure in the surface of the cured curable material; and
separating the casting relief structure and the support layer such that the cured curable material is carried by the support layer;
whereby the cured curable material applied in the first sub-region of the surface region carries a primary portion of the surface relief structure, the primary portion of the surface relief structure corresponding to at least a part of the casting relief structure in the casting surface, and the cured curable material applied in the second sub-region of the surface region carries an ancillary portion of the surface relief structure, the ancillary portion of the surface relief structure having a thickness that decreases from the primary portion of the relief structure towards a lateral edge of the cured curable material.

66. A method according to claim 65, wherein the application device is adapted to transfer the curable material onto the surface in the second sub-region with a volume per unit area that decreases across the second sub-region from the first sub-region towards the lateral edge of the curable material.

67. A method according to claim 65, wherein the application device comprises an application surface having an array of recesses located across an application surface region, the application surface region corresponding to the surface region, the array of recesses being configured to receive at least some of the curable material, wherein a first sub-set of the array of recesses are located across a first application surface sub-region corresponding to the first sub-region of the surface and are configured to transfer the curable material onto the surface in the first sub-region of the surface, and wherein a second sub-set of the array of recesses are located across a second application surface sub-region corresponding to the second sub-region of the surface and are configured to transfer the curable material onto the surface in the second sub-region of the surface, the average volume of the first sub-set of the array of recesses being greater than the average volume of the second sub-set of the array of recesses.

68. A method according to claim 67, wherein the recesses of the second sub-set of the array of recesses vary in their volume.

69. A method according to claim 65, wherein the application device comprises an application surface configured to receive the curable material, wherein the application surface comprises a surface relief across an application surface region, the application surface region corresponding to the surface region, wherein the surface relief has a first average height in a first application surface sub-region corresponding to the first sub-region of the surface and the surface relief has a second average height in a second application surface sub-region corresponding to the second sub-region of the surface, wherein the first average height is greater than the second average height.

70. A method according to claim 65, wherein the application device comprises an application surface configured to receive the curable material, wherein the application surface comprises a plurality of raised surface regions across an application surface region, the raised surface regions being configured to receive the curable material and the application surface region corresponding to the surface region, wherein a first sub-set of the plurality of raised surface regions are provided in a first application surface sub-region corresponding to the first sub-region of the surface and a second sub-set of the plurality of raised surface regions are provided in a second application surface sub-region corresponding to the second sub-region of the surface, and wherein the first sub-set of the plurality of raised surface regions make up a first proportion of the total area of the first application surface sub-region and the second sub-set of the plurality of raised surface regions make up a second proportion of the total area of the second application surface sub-region, the first proportion being greater than the second proportion.

71. A method according to claim 65, wherein the primary portion of the surface relief structure comprises an array of repeating surface relief elements.

72. A method according to claim 71, wherein the ancillary portion of the surface relief structure does not comprise the repeating surface relief element.

73. A method according to claim 71, wherein the second sub-region of the surface region extends away from the first sub-region of the surface region by a distance greater than half of the pitch of the array of repeating surface relief element.

74. A method according to claim 65, wherein the casting relief structure is provided across a casting region of the casting surface, the casting region being larger than the surface region.

75. A method according to claim 65, wherein the casting relief structure is provided across a casting region of the casting surface, the casting region being smaller than the surface region.

76. A method according to claim 65, wherein the second sub-region of the surface region has a minimum lateral dimension greater than 500 μm.

77. A method according to claim 65, wherein the second sub-region of the surface region provides at least 1% of the combined area of the first and second sub-regions of the surface region.

78. A method of forming a security device component comprising:
providing a support layer and a casting relief structure;
applying a curable material to a surface across a surface region;
wherein the surface is either a surface of the support layer or a casting surface of the casting relief structure;
bringing the casting relief structure and the support layer together across the surface region such that the curable material lays therebetween;
curing the curable material, thereby fixing a surface relief structure in the cured curable material; and
separating the casting relief structure and the support layer such that the cured curable material is carried by the support layer;
wherein
the casting relief structure is provided across a casting region of the casting surface, the casting region having a first casting sub-region and a second casting sub-region abutting the first casting sub-region, the first casting sub-region and the second casting sub-region defining different relief structures that together define the surface relief structure fixed in the cured curable material and the second casting sub-region providing at least one lateral edge of the casting relief structure, wherein the first casting sub-region defines a primary portion of the surface relief structure and wherein the second casting sub-region defines an ancillary portion of the surface relief structure, the ancillary portion of the surface relief structure having a thickness that decreases from the primary portion of the surface relief structure towards the at least one lateral edge of the surface relief structure.

79. A method according to claim 78, wherein the casting region is larger than the surface region.

80. A method according to claim 78, wherein the casting region is smaller than the surface region.

81. A method according to claim 78, wherein the first casting sub-region defines an optically active surface relief structure, and wherein the second casting sub-region defines an optically inactive surface relief structure.

82. A method according to claim 78, wherein the first casting sub-region defines an array of focussing elements, an array of prismatic surface elements, a diffractive relief structure, a refractive surface relief structure, a reflective relief structure and/or a tactile relief structure.

83. A method according to claim 78, wherein the relief structure of the first casting sub-region comprises an array of repeating surface relief elements.

84. A method according to claim 83, wherein the relief structure of the second casting sub-region does not comprise the repeating surface relief element.

85. A method according to claim 83, wherein the second casting sub-region extends away from the first casting sub-region by a distance greater than half of the pitch of the array of repeating surface relief elements.

86. A method according to claim 78, wherein the second casting sub-region has a minimum lateral dimension greater than 500 μm.

87. A method according to claim 78, wherein the second casting sub-region provides at least 1% of the combined area of the first and second casting sub-regions.

88. A security device component comprising a layer of cured curable material carrying a surface relief structure in the surface thereof, wherein a first sub-region of the surface relief structure has a first relief structure and a second sub-region of the surface relief structure, abutting the first sub-region, has a second relief structure different from the first relief structure, wherein the first relief structure defines a primary portion of the surface relief structure and the second relief structure defines an ancillary portion of the surface relief structure, the ancillary portion of the surface relief structure having a thickness that decreases from the primary portion of the surface relief structure towards at least one lateral edge of the layer of curable material.
